(19) United States
(12) Patent Application Publication
(10) Pub. No.: US 2021/0245455 A1
(43) Pub. Date: Aug. 12, 2021

(54) METHOD OF PRODUCING IMPROVED COMPOSITE FIBERS

(71) Applicant: USB I, LLC, Richmond, TX (US)

(72) Inventors: Oleksandr Biland, Richmond, TX (US); Robert Bruce Ferguson, SR., Richmond, TX (US)

(21) Appl. No.: 17/241,727

(22) Filed: Apr. 27, 2021

Related U.S. Application Data
(63) Continuation-in-part of application No. 16/376,567, filed on Apr. 5, 2019, now abandoned.
Application No. 16/376,567 is a division of application No. 15/424,538, filed on Feb. 3, 2017, now Pat. No. 10,369,754.

(51) Int. Cl. B29C 70/52; B29C 70/54; B29B 15/12; B29C 70/10; C08K 7/02; C04B 20/00

(52) U.S. Cl. CPC B29C 70/523; B29C 70/527; B29C 70/545; B29C 70/522; D01H 13/30; B29B 15/122; B29C 70/10; C08K 7/02; C04B 20/0068; B29C 70/524

(57) ABSTRACT

Improved composite fibers, and structural materials mixed with the improved composite fibers, are produced by an improved process that vertically texturizes and impregnates resin into the fibers without introducing any substantial amount of microbubbles in the resin. By using vertical impregnation and twisting of fiber strands with specific viscosity control, stronger composite fibers, in which substantially no microbubbles are trapped, are produced with improved tensile strength and lower variance in tensile strength, for use in strengthening structural concrete and other structural materials.

### CROSS-REFERENCE TO RELATED APPLICATIONS

This application is a continuation-in-part of and claims priority to U.S. patent application Ser. No. 16/376,567 filed on Apr. 5, 2019, titled “Composite Fibers and Method of Producing Fibers,” which is a divisional of and claims priority to U.S. patent application Ser. No. 15/424,538 filed on Feb. 3, 2017, titled “Composite Fibers and Method of Producing Fibers,” now issued as U.S. Pat. No. 10,369,754, which are both incorporated herein by reference in their entirety.

### BACKGROUND

### Field of the Disclosure

The present disclosure relates generally to composite fibers and, more particularly, to an improved method of producing improved composite fibers for various applications, such as for strengthening concrete.

### Description of the Related Art

Composite fibers are used for structural reinforcement of various construction or industrial materials such as concretes, mortars, soil stabilizing polymers, geo-polymers, asphalts, among others. Composite fibers made of mineral or glass fibers, in particular fiberglass and basalt fibers, along with thermoset resins, have been used in the construction industry. Such composite fibers may be relatively cheap, may have suitable mechanical properties, may be non-corrosive. In comparison to strengthening with steel fibers, such composite fibers may be lighter than steel, may be easier to cut and to apply, and may provide longer lifetimes. While such composite fibers may be economically competitive in price and performance with commonly used polypropylene fibers, the composite fibers may not result in comparable mechanical properties as with steel fibers, which may still impart greater mechanical properties to the final industrial material.

Typical composite fibers are produced by pultrusion that applies a coating to a fiber or a bundle of fibers using a die or a bath through which the fiber is pulled horizontally. Conventional processes for coating continuous fibers in this manner have resulted in porosity or voids or microbubbles becoming trapped between individual filament strands in the composite fiber. Such voids have been determined to adversely affect the tensile strength and the variance in tensile strength of the typical composite fibers, which is undesirable, particularly when the composite fibers are used as a strengthening additive, such as for concrete in structural applications.

### SUMMARY

In one aspect, a first method of producing a composite fiber is disclosed. The first method may include feeding a first core fiber vertically downwards through a first texturizer to form a first texturized fiber, feeding a second core fiber vertically downwards through a second texturizer to form a second texturized fiber, and feeding the first texturized fiber and the second texturized fiber vertically downwards into a top end of a resin impregnator. The first method may also include rotating the first texturizer and the second texturizer about each other at a specified angular velocity while a resin is injected into the resin impregnator at a viscosity less than or equal to a maximum viscosity, the rotating being effective to twist the first texturized fiber and the second texturized fiber about each other with a specified winding pitch to form an impregnated fiber. In the first method, a surface of the resin in the resin impregnator may be maintained above a point of twisting together of the impregnated fiber, while microbubbles present in the resin may be enabled to evacuate upwards via the surface of the resin. The first method may also include pulling the impregnated fiber downwards from a bottom end of the resin impregnator and curing the resin in the impregnated fiber to form the composite fiber comprising the cured resin.

In any of the disclosed embodiments of the first method, the maximum viscosity may be 5 mPa*s.

In any of the disclosed embodiments of the first method, the specified angular velocity may be effective to produce the specified winding pitch of at least 1 winding per inch.

In any of the disclosed embodiments, the first method may further include pulling the impregnated fiber into a precuring channel to form a precured fiber and pulling the precured fiber into a shaper to impart a shape to the precured fiber to form a shaped fiber.

In any of the disclosed embodiments of the first method, the precured fiber may have a resin viscosity of at least 10⁶ Pa*s.

In any of the disclosed embodiments of the first method, the shape may be selected from at least one of: a wave, a triangle, a square, a curve, or an angle.

In any of the disclosed embodiments of the first method, the shape may be periodic along the length of the shaped fiber.

In any of the disclosed embodiments, the first method may further include pushing the shaped fiber into a curing channel to form the composite fiber and pushing the composite fiber to a cutter to cut the composite fiber to a desired length.

In any of the disclosed embodiments of the first method, the core fiber may consist of basalt.

In any of the disclosed embodiments of the first method, the core fiber may include at least one of: igneous rock fiber, carbon fiber, aramid fiber, and glass fiber.

In any of the disclosed embodiments of the first method, the igneous rock fiber may further include igneous rock selected from at least one of: feldspar, quartz, feldspathoid, olivine, pyroxene, amphibole, and mica.

In any of the disclosed embodiments of the first method, the composite fiber may exhibit a variance in tensile strength of maximum 5% among different process batches.

In another aspect, a second method of producing a structural composite material is disclosed. The second method may include mixing a structural material for supporting structural loads with a composite fiber. In the second method, the composite fiber may be produced according to a third method comprising feeding a first core fiber vertically downwards through a first texturizer to form a first texturized fiber, feeding a second core fiber vertically downwards through a second texturizer to form a second texturized fiber, and feeding the first texturized fiber and the second texturized fiber vertically downwards into a top end of a resin impregnator. In the second method, the third method may further include rotating the first texturizer and the second texturizer about each other at a specified angular velocity while a resin is injected into the resin impregnator at a viscosity less than or equal to a maximum viscosity, the rotating being effective to twist the first texturized fiber and the second texturized fiber about each other with a specified winding pitch to form an impregnated fiber. In the third method, a surface of the resin in the resin impregnator may be maintained above a point of twisting together of the impregnated fiber, while microbubbles present in the resin may be enabled to evacuate upwards via the surface of the resin. In the second method, the third method may further include pulling the impregnated fiber downwards from a bottom end of the resin impregnator and curing the resin in the impregnated fiber to form the composite fiber comprising the cured resin.

In any of the disclosed embodiments of the second method, the structural material may include at least one of: concrete, mortar, soil-stabilizing polymer, geo-polymer, and asphalt.

In any of the disclosed embodiments of the second method, the composite fiber may be a shaped fiber.

In any of the disclosed embodiments of the second method, composite fiber may be cut to a specified length.

In any of the disclosed embodiments of the second method, the core fiber may consist of basalt.

In any of the disclosed embodiments of the second method, the core fiber may include at least one of: igneous rock fiber, carbon fiber, aramid fiber, and glass fiber.

In any of the disclosed embodiments of the second method, the composite fiber may exhibit a variance in tensile strength of maximum 5% among different process batches.

In any of the disclosed embodiments of the second method, mixing the structural material with the composite fiber may further include mixing using a dry mix ratio of 12 pounds of the composite fiber to 1 cubic meter of the structural material, while the structural material may be a dry powder.

### BRIEF DESCRIPTION OF THE DRAWINGS

For a more complete understanding of the present invention and its features and advantages, reference is now made to the following description, taken in conjunction with the accompanying drawings, in which:

FIG. 1A is prior art depiction of conventionally pultruded reinforced fiber and illustrates weakening and breakage due to microbubbles in the fibers;

FIG. 1B is a prior art plot of tensile strength of 100 samples of conventionally pultruded basalt fiber from a single batch;

FIG. 2 is a prior art flow diagram of a conventional pultrusion process practiced in a horizontal orientation;

FIG. 3A is a flow diagram of an embodiment of an improved pultrusion process;

FIG. 3B is a flow diagram of an embodiment of an improved pultrusion process;

FIG. 4 is a diagram of an embodiment of an improved pultrusion apparatus;

FIG. 5 is a plot of tensile strength of 100 samples of pultruded basalt fiber from a single batch; and

FIG. 6 is a flow chart of a method for forming composite fibers free of microbubbles.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

The present disclosure is related to the field of composite fibers for structural reinforcement of various construction or industrial materials, as noted above. As discussed, composite fibers may not attain comparable structural properties when used in industrial materials as compared to steel fibers. For example, typical composite fibers, even composite fibers from the same processing batch, may exhibit large variances in their mechanical properties that negatively impact the structural characteristics of reinforced concrete or other industrial material in which the composite fibers are mixed into.

Pultrusion is a continuous process for the manufacturing of composite materials with a constant cross-section, and is a commonly used method in the production of composite fibers. The term ‘pultrusion’ is a portmanteau word that combines “pulling” and “extrusion” to distinguish from conventional extrusion, which pushes material under force or pressure. For composite fibers in particular, pultrusion involves applying tension while also extruding a coating or a matrix, such as a curable resin.

The present disclosure is directed to a method or process for manufacturing of composite fibers and to the composite fibers manufactured by the disclosed process herein. In particular, the present disclosure relates to composite basalt fibers coated with a resin and usable for reinforcing and strengthening concrete. As noted, a pultrusion process is typically used to apply a coating to a continuous fiber, where tension is applied to the continuous fiber while the coating may be applied using a die or an open bath through which the continuous fiber is passed.

In a conventional pultrusion process for coating fibers, the direction of tension in the fiber and the orientation of the die through which the fiber is pulled for applying the coating are both horizontal. The fiber may be in the form of fiber strands that are composed of thousands of filaments. In some pultrusion processes, a sizing agent, such as a sizing film in some applications, may first be applied to the filaments. The purpose of the sizing agent is to protect and lubricate the filaments and to hold the filaments together as a fiber strand with a given size. The sizing agent may be a sprayed film or may be a more viscous coating that is applied using a die. The sizing agent typically comprises a film forming agent, such as a silane, along with a coupling agent. Thus, the sizing agent may be chemically compatible for adhesion of the resin coating that is subsequently applied, as described below. It is noted that various different compounds and chemical mixtures may be used as the sizing agent in different embodiments and for different types of filaments and fibers.

After the sizing agent is applied, or in some cases using a fiber or a filament directly without the sizing agent, a resin coating is then applied to form the composite fiber. The resin coating may also be applied with a die or with an open resin bath through which the fibers, fiber strands, or filaments are passed. The resin coating may be subsequently cured, such as by thermosetting, to form the final composite fiber.

Analysis of fiber samples from each stage of such a conventional pultrusion process has revealed that a large number of gas microbubbles are introduced during impregnation of the fiber strands with the resin coating. Further, the morphology of the filaments has shown that the sizing agent does not typically result in a uniform, even film coating of the filaments. Rather, the sizing agent typically results in a plurality of surface irregularities that are uneven and heterogeneous. Gas molecules may be entrained by the surface irregularities and are observed as microbubbles within the bundle of filaments strands prior to application of the resin. As described in further detail below, the microbubbles may remain in the composite fiber and may result in weakening of the composite fiber itself, which is undesirable and disadvantageous in further applications, such as for mixing the composite fibers into concrete as a strengthening agent. Furthermore, it has been observed and will be described in further detail below, that the presence of the microbubbles in the conventionally pultruded composite fiber also increases the variance of the strength of the fibers, in addition to reducing the average strength, which is further undesirable and disadvantageous.

Methods of producing composite fibers are disclosed herein. The composite fibers may be suitable for cutting into short lengths and blending into materials such as concrete, for example, as structural reinforcement. The core fiber used to make the composite fiber may be inorganic and may comprise igneous rock such feldspars, quartz, feldspathoids, olivines, pyroxenes, amphiboles, and micas, or combinations thereof In certain embodiments, the core fiber used to make the composite fiber may comprise basalt, carbon fibers, aramid, para-aramid, or meta-aramid fibers such as used in Kevlar®, Nomex® and related products. In some embodiments, the core fiber used to make the composite fiber may comprise glass fibers. In various embodiments, various combinations of the aforementioned core fibers may be used in any particular application. In particular embodiments, the core fiber used to make the composite fiber are obtained from igneous rock melt comprising basalt. An apparatus and process for producing fiber from igneous rock is described in U.S. Provisional Application No. 62/350,832, filed on Jun. 16, 2016, and U.S. patent application Ser. No. 15/624,305 filed on Jun. 15, 2017, now issued as U.S. Pat. No. 10,858,275 B2 on Dec. 8, 2020, which are incorporated herein in their entirety by reference.

The method and apparatus for producing composite fiber disclosed herein may enable feeding fibers vertically down through a texturizer, effective to separate individual filaments of the fiber, and to inhibit the fibers sticking together, such that the texturized fibers are unstrained. The unstrained texturized fibers may then fed vertically down through a resin impregnation device that may impregnate the fibers with resin, degas the resin of microbubbles, and apply tension to the impregnated fiber. Various resins may be used in pultrusion including polyester, polyurethane, vinyl-ester and epoxy.

The disclosed method and apparatus may stabilize the resin at a desired viscosity for injection into the resin impregnation device, while a plurality of fiber spools are rotated to twist the fibers into a single strand of impregnated fiber, such that a twisting point is below a level of resin in the resin impregnation device. The desired viscosity may be less than or equal to a maximum viscosity. In this unique manner, at least a portion of, or substantially all trapped microbubbles may be evacuated via a horizontal surface of the resin. A combination of rotational speed and linear speed may be used to achieve a desired winding pitch. The impregnated fiber may be squeezed with pressing rollers to squeeze out more microbubbles or to apply tension. In certain embodiments, the impregnated fiber is pulled from the bottom of the resin impregnation device, into the precuring station for precuring. The precured fiber can then be pulled through shaping grips to impart a shape, and to push shaped fiber without tension from the shaping grips. The shaping grips may be a single element or may involve several successive process elements. The shaped fiber may then be pushed through a curing station without applying tension. The shaped, cured fiber may then be pushed into a cutter for cutting into desired lengths corresponding to various applications of the final improved composite fiber, such as for strengthening concrete, strengthening mortar, strengthening soil stabilizing polymers, strengthening geo-polymers, or strengthening asphalts.

In certain embodiments the resin is supplied to the resin impregnation device at a specified viscosity by passing the resin through a viscosity stabilizer that is directly connected to a resin metering mixing device that feeds the resin into the resin impregnation device. The resin can be any suitable resin, and can be a thermoset resin or a thermoplastic resin for example. In certain embodiments, the resin comprises at least one of polyester, polyurethane, vinyl-ester or epoxy. In certain embodiments, the impregnated fiber can be pulled into a precuring station and partially cured to achieve a viscosity of about 10⁶ Pa*s. Shaping grips may then imprint or impart a shape to the precured fiber, while the shape can be a wave pattern, a triangle pattern, an curve pattern, or a square pattern, among others. The shape may be a discrete shape, a continuous shape, or a periodic shape along the length of the precured fiber.

In particular embodiments, the improved composite fibers produced according to the improved pultrusion process disclosed herein comprise basalt fibers as the core fiber. For example, the core fiber, which is supplied as a fiber roving spool, may be substantially comprised of basalt fibers or may consist of basalt fibers. The core basalt fiber material used may exhibit an average tensile strength of about 419 ksi, in certain embodiments, which may be useful for concrete reinforcement or strengthening. It is noted that the effective tensile strength may depend on many factors, such as a composition of core fibers, along with process steps in the improved pultruding process.

The present disclosure is also directed to improved composite fibers made using the improved pultrusion process disclosed herein. The present disclosure is also directed to the improved structural materials produced by mixing with the improved composite fibers disclosed herein, including but not limited to improved concrete, improved mortar, improved soil stabilizing polymer, improved geo-polymer, and improved asphalt.

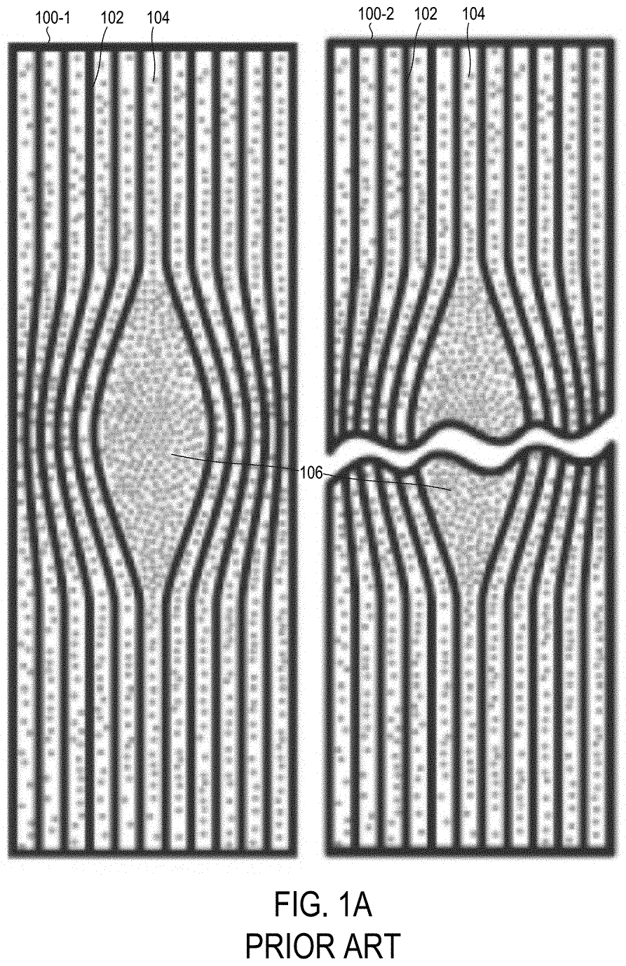

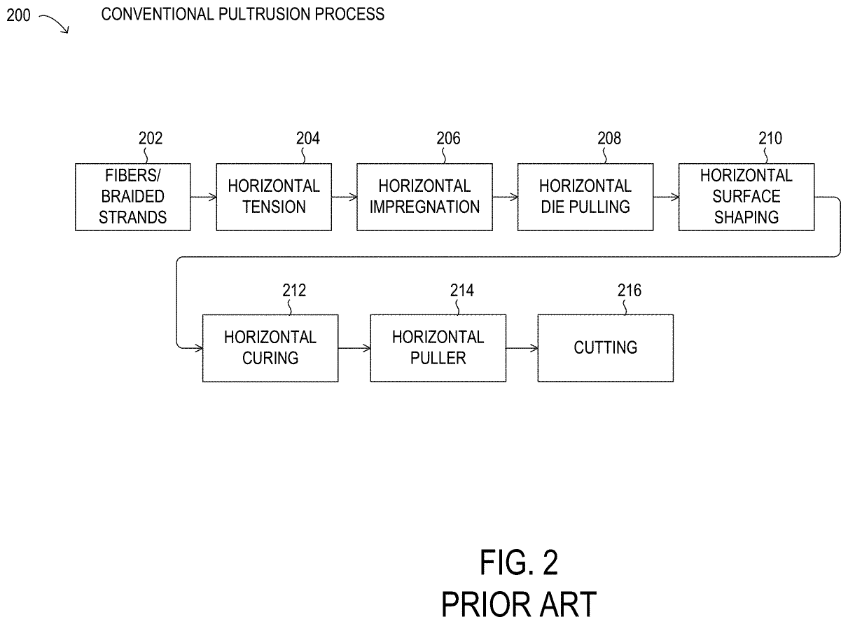

Turning now to the drawings, FIG. 1A depicts an illustration of a fiber bundle 100 comprised of filaments 102 as well as a certain distribution of microbubbles 104. On the left of FIG. 1A is a fiber bundle 100-1 that is formed with a large void 106 as well as the distribution of microbubbles 104 throughout. In the right of FIG. 1A is a fiber bundle 100-2 that depicts a failure or breaking of fiber bundle 100-1 after being subjected to a tensile load. As noted above, an analysis of prior art composite fibers 100 was performed and included analysis of images of filaments 102 taken by a scanning electron microscope (SEM). The SEM analysis revealed that the sizing agent used for pre-coating conventionally produced prior art composite fiber bundles 100 is not flawless, and that the filaments' surfaces are uneven and heterogeneous. Further SEM examination of the shape, size, texture and phase distribution of the conventionally produced prior art composite fiber bundles 100 revealed a large number of unevenly distributed gas microbubbles 104 between the filaments 102 within the cured resin, as shown in FIG. 1A. The microbubbles 104 are voids and accordingly cause stress concentration in the remaining material of fiber bundles 100. Under loading, fiber bundles 100-2 may break at locations of maximum accumulation of microbubbles 104, such as large void 106. Moreover exfoliation of filaments 102 and poor adhesion of filaments 102 to the resin matrix are observed at the specific locations of breakage, indicating that microbubbles 104 are associated with reduced tensile strength and an increase in variance of tensile strength, as shown in prior art FIG. 1B (see also FIG. 5). As fiber bundle 100 is subjected to the resin during the conventional impregnation process 206 (see prior art FIG. 2), the gas molecules 104 may remain trapped inside fiber bundle 100. It has been observed that the further process steps in a conventional pultrusion process 200 (see prior art FIG. 2), such as subsequent heating, squeezing, or curing, do not result in evacuation of microbubbles 104, once present. For example, a typical viscosity of the resin used in conventional pultrusion process 200 may be sufficiently high during impregnation to prevent microbubbles 104 from escaping, such that microbubbles 104 remain in the pultruded composite fiber, as shown in fiber bundle 100. The trapped microbubbles 104 may cause both a weakening of the mechanical strength of fiber bundle 100, as well as an increase in the variance of the mechanical strength from sample to sample produced in this conventional manner (see FIG. 1B).

The analysis of prior art composite fibers mentioned above included tensile testing of composite fibers from different manufacturers and revealed that failure loads for such samples, even samples from within the same production batch, may vary by more than a factor of 2, as shown in FIG. 1B. As shown in FIG. 1B, for example, results of tensile testing of 100 different samples from the same production batch exhibited an average tensile strength of about 256.8 ksi (kilopounds per square inch) with a variance of about 37% above and below the average value. For comparison, steel fibers were also tensile tested and did not exhibit a comparable variance. Although using basalt fibers to strengthen concrete, for example, may offer certain advantages over steel fiber-reinforced concrete, concrete reinforced with conventional composite fibers produced by conventional pultrusion process 200, or a similar prior art process, may be more prone to delamination and premature cracking, as evidenced by the low average tensile strength and the large variance in the tensile strength of the conventional composite fibers, as shown in FIG. 1B.

FIG. 2 is a prior art flow diagram of conventional pultrusion process 200 practiced in a horizontal orientation. In conventional pultrusion process 200, the core fibers or braided strands 202 (or simply fibers 202) may be pulled horizontally, at step 204, through a creel guide and tension rollers. At step 206, fibers 202 are impregnated with resin in a horizontal orientation, such as by immersion in a resin bath. In some embodiments of conventional pultrusion process 200, a separate preforming operation may follow horizontal impregnation 206. At step 208, fibers 202 are pulled through a heated stationary die, such that the resin may undergo polymerization. The impregnation at steps 206 and 208 may be performed by pulling fibers 202 through a bath or by injecting the resin into an injection chamber that is in fluid communication with the heated stationary die. At step 210, fibers 202, after impregnation with resin, is horizontally pulled through a surface shaping station. At step 212, the impregnated resin on fibers 202 is horizontally cured, such as by using a preheated curing chamber through. At step 214, a horizontal puller may provide linear horizontal tension on fibers 202 that results in movement through the previous steps in conventional pultrusion process 200. At step 216, fibers 202, now formed as composite fibers 202, are cut to desired lengths at a cutting station, while the cut composite fibers 202 are collected to end conventional pultrusion process 200.

The present disclosure addresses the problem of poor tensile strength and high variance of tensile strength from sample to sample in conventional composite fibers by providing a method and an apparatus that maintains the resin free from gas bubbles using a vertically arranged process of manufacturing that results in a uniquely improved composite fiber, as will now be described in further detail.

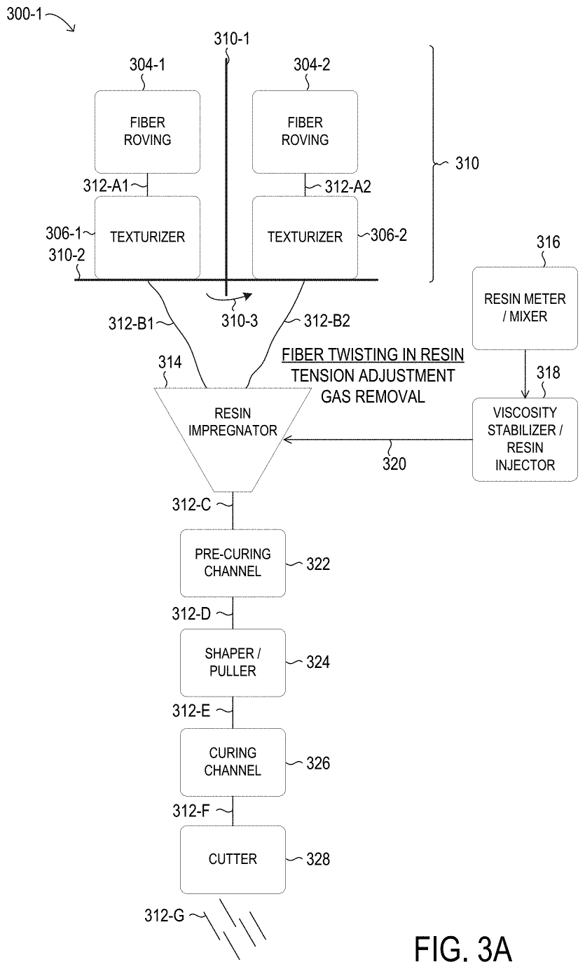

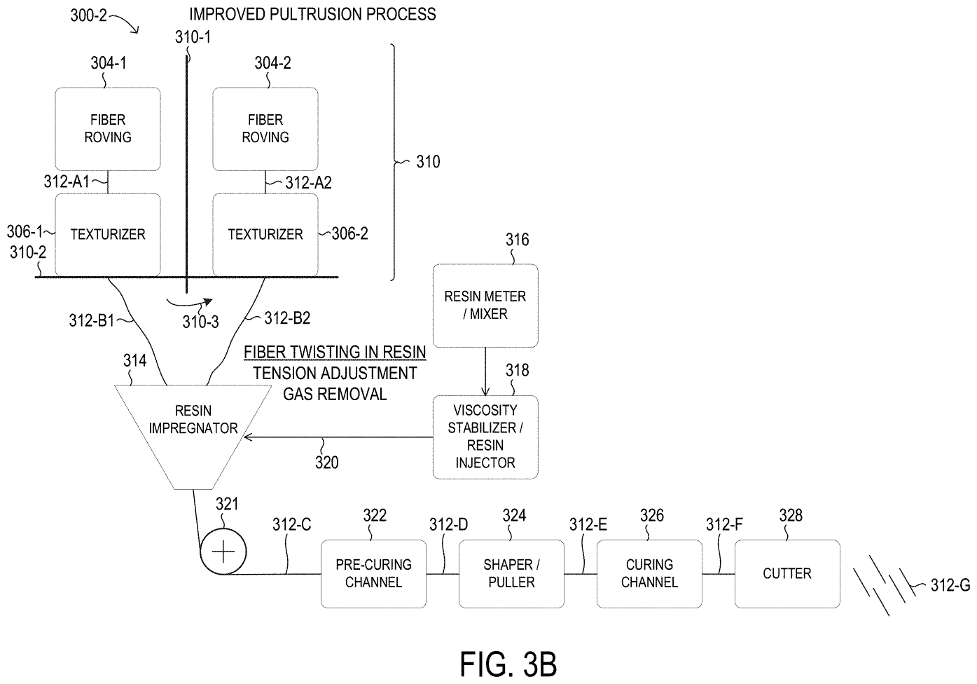

Referring now to FIGS. 3A and 3B, an improved pultrusion process 300 is depicted in schematic form that provides for vertically arranged impregnation to manufacture improved composite fibers. In FIG. 3A, improved pultrusion process 300-1 is depicted in a complete vertical arrangement with respect to the movement or travel of fibers 312 within improved pultrusion process 300-1. In FIG. 3B, improved pultrusion process 300-2 is depicted in a partial vertical arrangement with respect to the movement or travel of fibers 312 within improved pultrusion process 300-2. Improved pultrusion process 300 may be used as a continuous process for manufacturing an improved composite fiber, such as an improved composite fiber having a specified cross-sectional area. As shown, improved pultrusion process 300 can be used to produce improved composite fibers that are substantially free of microbubbles (see microbubbles 104 in prior art FIG. 1A) and thus, exhibit higher tensile strength and lower variance in the tensile strength than conventional composite fibers. As a result, structural products (not shown), such as formed with concrete strengthened with the improved composite fibers produced by improved pultrusion process 300, may exhibit increased structural strength and improved consistency, as compared to conventional structural products formed using conventional composite fibers 100 (see prior art FIG. 1A). In addition to the vertical arrangement of improved pultrusion process 300, as will be described in further detail below, improved pultrusion process 300 may also comprise and provide for precise control of the resin viscosity and precise control of the tension of fibers 312.

As shown in FIG. 3A, improved pultrusion process 300 comprises a roving table 310 that is enabled to carry one or more spools of fiber roving 304 that may be wound around a respective bobbin, for example. The spools of fiber roving 304 represent the core fiber, as described above, and may be basalt fibers in particular embodiments. Roving table 310 may have a base plate 310-2 that is mounted to a central axis 310-1 and is enabled to rotate about central axis 310-1, such as shown by a rotational direction arrow 310-3. As shown, roving table 310 carries two spools of fiber roving 304-1 and 304-2 in an exemplary embodiment selected for descriptive clarity. It will be understood that two or more spools of roving 304 may be used in various embodiments. From unwinding of fiber roving 304, a fiber 312-A represents an unwound state of fiber that is fed to a texturizer 306 that is also supported by roving table 310 and correspondingly rotates along with roving table 310. Thus, as roving table 310 rotates, fiber roving 310-1 unwinds fiber 312-Al that is fed to texturizer 306-Al that feeds out fiber 312-B1 that has been pre-textured, while simultaneously, fiber roving 304-2 unwinds fiber 312-A2 that is fed to texturizer 306-A2 that feeds out fiber 312-B2 that has been pre-textured. The spool of fiber roving 304 may be internally unwound, while texturizer 306 may separate individual filaments of fiber 312-A, such as to prevent clumping or sticking together of the filaments. It is noted that fibers 312-A and 312-B may be at a minimal tension and may be substantially unstrained in a vertical direction of travel.

As shown in FIG. 3A, from roving table 310, fibers 312-B1 and 312-B2 are fed into resin impregnator 314, which may be a funnel-shaped receptacle with an opening at a bottom side. Resin impregnator 314 may be enabled to receive fibers 312-B1 and 312-B2 vertically from above and may enable fibers 312-B1 and 312-B2 to be twisted about each other within resin impregnator 314 as roving table 310 rotates according to rotational direction arrow 310-3. Additionally, resin impregnator 314 may be in fluid communication with a conduit 320 that carries the resin for impregnation and fills resin impregnator 314 with a sufficient level of resin as fibers 312-B1 and 312-B2 are twisted about each other, such as a level of resin that remains above an initial twisting point of the two fibers. The opening at the bottom of resin impregnator 314 from which the twisted, impregnated fiber 312-C emerges may also work as a die that provides tension to fiber 312-C and may provide an opening having a desired diameter for application of a given volume of weight fraction of resin in fiber 312-C while maintaining a given diameter of fiber 312-C in the continuous process.

In FIG. 1A, the resin (not shown) may be provided as unmixed components (such as a base resin and a curing agent) to a resin meter/mixer 316 that can quantitatively dose (or meter) a given mixed fraction of the unmixed components as well as a total volume of mixed resin. The metered and mixed resin may be fed to a viscosity stabilizer/resin injector 318 that may regulate the viscosity of the resin and deliver the resin at a desired pressure and viscosity to resin impregnator 314 via the conduit 320. In various embodiments, viscosity stabilizer/resin injector 318 may apply thermal conditioning or heating to the mixed resin from resin meter/mixer 316 to regulate the viscosity.

In FIG. 1A, as fibers 312-B1 and 312-B2 rotate about each other, as described, and are wound together within resin impregnator 314, fibers 312-B1 and 312-B2 are also impregnated with the resin that fills resin impregnator 314 above an initial twisting point of fibers 312-B1 and 312-B2 and that is provided and regulated in volume and pressure and viscosity by viscosity stabilizer/resin injector 318 via conduit 320. Furthermore, due to the regulated viscosity, which may be kept below a given viscosity, as well as the twisting action of fibers 312-B1 and 312-B2, any entrapped microbubbles may be pressed out from within fibers 312-B1 and 312-B2 and can freely rise to the surface of the resin in resin impregnator 314 and escape into the surrounding air, resulting in fibers 312-C that are substantially free of the microbubbles.

In particular embodiments, a maximum viscosity for the resin provided via conduit 320 may be about 5 millipascal-seconds (mPa*s) to ensure sufficient removal of the microbubbles. In some embodiments, the maximum viscosity may be about 1, 2, 3, 4, or 5 mPa*s. It is noted that a different maximum viscosity of the resin provided by conduit 320 may be regulated in different embodiments. In various embodiments, a rate of rotation of roving table 310 may be selected, along with a velocity of fiber 312 moving along improved pultrusion process 300 to define a winding pitch in fiber 312-C, for example, that may be selected to be between about 5 windings per inch to about 25 windings per inch and may depend upon various other factors and parameters of improved pultrusion process 300. In various embodiments, winding pitch may be from about 1 winding per inch to about 50 windings per inch, or from about 3 windings per inch to about 35 windings per inch. The winding pitch may be selected to optimize a tensile strength of fiber 312-F, such as by ensuring removal or absence of sufficient amounts of the microbubbles in fiber 312-C, including substantially eliminating the microbubbles.

In some embodiments, pressing rollers (not shown) may additionally be used to squeeze or to apply pressure to fibers 312-B1 and 312-B2 during or after twisting together at resin impregnator 314. The pressing rollers may serve to further evacuate microbubbles from fibers 312-B, as desired, or may serve to remove excess resin prior to curing. The pressing rollers may be included within resin impregnator 314 or may be subsequent to resin impregnator 314. The pressing rollers may provide additional pretension to fiber 312-C prior to shaper/puller 324, as will be described below.

It is noted that, as used herein, the term ‘vertical’ can include some variance from an absolutely perpendicular direction to the horizontal plane. In operation of resin impregnator 314, fibers 312-B may be texturized at texturizer 306, coated with resin, and twisted together while oriented in a substantially vertical manner that is effective to release entrapped microbubbles from filaments in fibers 312-B and to allow the microbubbles to rise to the surface of the resin, resulting in fibers 312-C that are substantially free of the microbubbles. Accordingly, fiber 312-C may be twisted, impregnated with resin, substantially free from microbubbles, pretensioned or tensioned, while the resin is uncured.

As shown in FIG. 3A, subsequent to resin impregnator 314, fiber 312-C is fed to pre-curing channel 322, where the resin may be partially cured. From pre-curing channel 322, fiber 312-D may be received by a shaper/puller 324 that may further apply tension and may impart a geometric shape to fiber 312-D, such as to increase a linear surface area of fiber 312-D or to introduce longitudinal corners or edges to fiber 312-D. The shaping of fiber 312-D by shaper/puller 324 may result in fiber 312-F that can bond with a higher bonding strength to matrix, such as when fiber 312-G is added to concrete as a strengthening agent. From shaper/puller 324, fiber 312-E is passed through curing channel 326 that completely cures the resin.

As noted, the resin used may be a thermoset resin, such as at least one of polyester, polyurethane, vinyl-ester and epoxy, such that pre-curing and curing may involve applying heat to fiber 312. It is noted that, in certain embodiments, exothermic resins may be used that involve cooling during curing, such that pre-curing channel 322 and curing channel 326 may include cooling elements. After pre-curing at pre-curing channel 322, the resin in fiber 312-D may exhibit a viscosity of around 10⁶ pascal-seconds (Pa*s) in particular embodiments. At shaper/puller 324, the partially cured resin in fiber 312-D may be subject to shaping grips that provide triple mechanical action, such as pulling-shaping-pushing. In some embodiments, fiber 312-E leaving shaper/puller 324 may be pushed forward and may have substantially reduced tension or minimal tension prior to final curing at curing channel 326, which may ensure that the desired shape imparted at shaper/puller 324 is not distorted. Accordingly, in some embodiments, after shaper/puller 324, fiber 312-E may be pushed through curing channel 326.

After emerging from curing channel 326, fiber 312-F may have resin that is sufficiently or fully cured (such as sufficiently or completely polymerized) and may be formed in the desired shape of the improved composite fiber. Accordingly, fiber 312-F and 312-G may be solidified and substantially free of microbubbles. At a cutter 328, continuous fiber 312-F may be forwarded and cut into discrete lengths of desired size that may be collected as fibers 312-G that are ready for mixing into an industrial material, such as concrete, for example as a strengthening agent. For example, for concrete reinforcement, the fibers 312-G may be cut to lengths from about 1 inch to about 5 inches, or from about 2 inches to about 4 inches, of about 1 inch, about 2 inches, about 3 inches, about 4 inches, or about 5 inches.

In FIG. 3B, improved pultrusion process 300-2 is shown as a second embodiment of improved pultrusion process 300. Improved pultrusion process 300-2 may include substantially similar or identical elements as improved pultrusion process 300-1 that are described above. However, in addition to the elements disclosed with respect to improved pultrusion process 300-1 in FIG. 3A, in improved pultrusion process 300-2 of FIG. 3B, a diverting roller 321 is included that diverts fiber 312-C about 90 degrees from a substantially vertical orientation to a substantially horizontal orientation for the remaining process steps. It is noted that improved pultrusion process 300-2 incorporates the same orientation of resin impregnator 314 that enables fiber 312-C to be substantially free of microbubbles, as explained in detail herein.

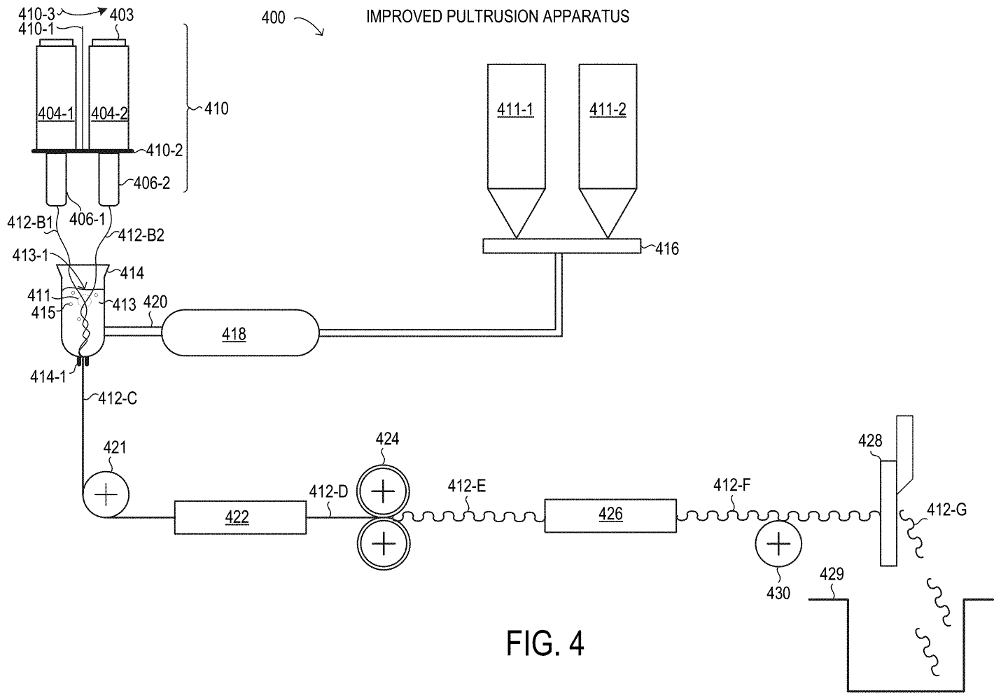

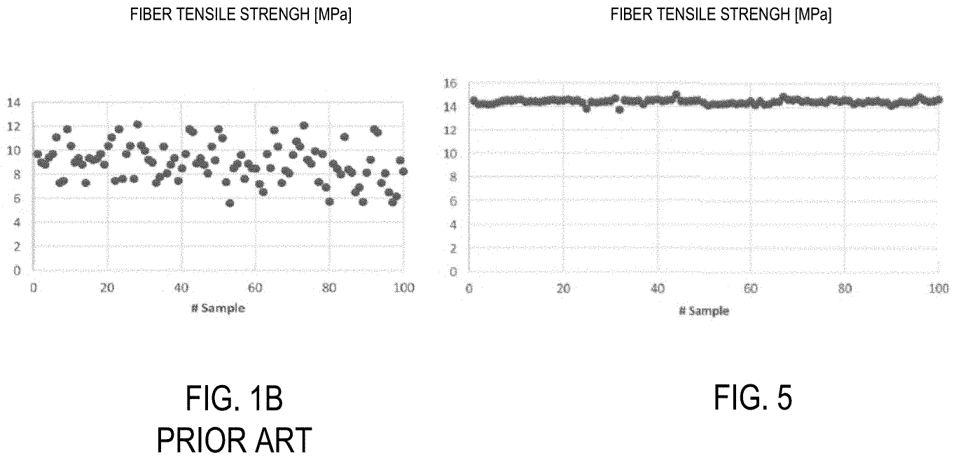

Referring now to FIG. 4, an improved pultrusion apparatus 400 is depicted in schematic form. The equipment schematically depicted in improved pultrusion apparatus 400 may correspond to improved pultrusion process 300-2 shown in FIG. 3B and may operate in a substantially similar manner as described above with respect to FIGS. 3A and 3B. Therefore, the following description of improved pultrusion apparatus 400 explains the equipment present, while operational details have already been explained with respect to improved pultrusion apparatus 300 above.

As shown in FIG. 4, improved pultrusion apparatus 400 is shown enabled for feeding two fiber rovings 404-1, 404-2, which may be spools of raw fiber that are used as the core fiber. Fiber roving 404 is wrapped around a bobbin 403 that is hollow and has a cylindrical opening internally where fiber roving 404 may be unwound from. Bobbin 403 is mounted on a base plate 410-2 of a roving table 410 that includes a spindle 410-1 about which bobbin 403 rotates to unwind fiber roving 404. Base plate 410-2 may have an opening that is in fluid communication with bobbin 403 and also in fluid communication with texturizer 406 that is mounted on a bottom surface of base plate 410-2. Accordingly a fiber (412-A, not visible in FIG. 4) may be internally unwound from fiber roving 404 through bobbin 403, base plate 410-2 and may be fed into texturizer 406-2 where the fiber passes through and where any filaments in the fiber are untangled and delaminated from each other. The fiber emerges from texturizer as fiber 412-B, while the internal unwinding described above is obscured from view in FIG. 4. Roving table 410 is enabled to rotate in a direction given by arrow 410-3 about spindle 410-1 that represents a central axis of rotation. Individual fibers 412-B1, 412-B2 are fed into a top end of resin impregnator 414, which may be a crucible-like vessel and in which fibers 412-B1, 412-B2 are twisted together while a resin 413 fills resin impregnator 414. Resin 413 is supplied by a conduit 420 having an inlet port in resin impregnator 414. Conduit 420 leads from viscosity stabilizer/resin injector 418 which may provide temperature control of resin 413. Resin 413 may also be heated in resin impregnator 414 (not shown) in some embodiments. Resin impregnator 414 may be insulated for thermal equilibrium.

As shown in FIG. 4, resin 413 may be filled to a level having a surface 413-1 and may be maintained such that surface 413-1 is above a twisting point 411 of fibers 412-B1, 412-B2. Also visible are microbubbles 415 that are enabled to evacuate resin 413 by rising to surface 413-1 by virtue of the twisting action as well as the sufficiently low viscosity of resin 413.

In FIG. 4, resin impregnator 414 also has an outlet port 414-1 at a bottom end, which may function as a die to shape fiber 412-C that is impregnated. Outlet port 414-1 may also impart a tension to fiber 412-C, which was previously substantially untensioned during twisting and impregnation within resin impregnator 414. Impregnation within resin impregnator 414 may enable fiber 412-C to be substantially free of microbubbles, as described previously. A resin meter/mixer 416 may be enabled to meter and mix two fluid components 411-1, 411-2, which may be a base resin, such as at least one of polyester, polyurethane, vinyl-ester and epoxy, and a curing agent or a hardening agent that promotes cross-linking and polymerization. As fiber 412-C emerges from outlet port 414-1 after impregnation, resin meter/mixer 416 may supply mixed resin at a sufficient rate to maintain a constant level of resin 413 in resin impregnator 414.

As shown in FIG. 4, a diverting roller 421 may turn fiber 412-C horizontally from vertical such that the rest of improved pultrusion apparatus 400 operates in a horizontal orientation. Diverting roller 421 may also have some squeezing or pressing action on fiber 412-C and may apply tension to fiber 412-C. Next fiber 412-C is fed into a pre-curing channel 422 that may be temperature controlled to achieve a partial curing of the resin, as described above. As fiber 412-D emerges after pre-curing, fiber 412-D is fed into a shaper/puller 424 that may impart a geometrical shape, shown as fiber 412-E. Although a wave pattern is shown for descriptive clarity, it is noted that various shapes or patterns may be formed by shaper/puller 424, as noted above. Fiber 412-E, which may no longer be in tension and may be pushed along, is fed into curing channel 426 for final curing of the resin, and emerges as fiber 412-F that is cured. Fiber 412-F may be pushed and supported by a traction roller 430 and fed into a cutter 428 for cutting into specified sized segments, shown as fiber 412-G. Fiber 412-G may be collected in a receptacle 429 and may be packaged for final delivery.

In FIG. 4, fibers 412-B1, 412-B2 are texturized, unsaturated, and nearly tension-free strands. Fibers 412-C are resin impregnated, free of microbubbles, twisted to a specified pitch, while the resin is not cured. Fiber 412-D is pre-cured and unshaped. Fiber 412-F is fully cured, shaped, free of microbubbles, and continuous. Fiber 412-G is cut to length and usable as a composite fiber for structural reinforcement.

Referring now to FIG. 5, fiber tensile strength of fiber 412-F and 412-G (see FIG. 4) is shown as a plot for 100 samples. FIG. 5 is shown next to prior art FIG. 1B with aligned Y-axes to enable comparison of the values displayed in each plot to each other. As shown, the tensile strength of prior art fiber 100 in prior art FIG. 1B is lower on average and exhibits a greater variance than the tensile strength of fiber 412-F/G shown in FIG. 5. Specifically, tensile testing showed that 100 samples from different batches of fiber 412-F/G had an average tensile strength of around 419.18 ksi and with a variance of about maximum 5% above and below a mean value, as shown in FIG. 5. In various embodiments, fiber 412-F/G may exhibit a variance in tensile strength among batches of less than 30%, less than 20%, less than 10%, less than 5%, or no more than 2%, 3% or 4%. The values in FIG. 5 are an almost 60% improvement over the prior art values shown in FIG. 1B. A morphological study of shape, size, texture and phase distribution of composite fibers 412-F/G confirms that substantially no microbubbles are present within and between individual filaments. Accordingly, it is estimated that an average residual strength of a concrete slab (standard 4,500 psi-rated concrete) with reinforced fibers 412-G (mix ratio of 12 pounds of dry fiber 412-G per 1 cubic meter of dry concrete powder) may be about 3,176 psi, which is about a 50% improvement in strength over a concrete slab reinforced with prior art fibers 100.

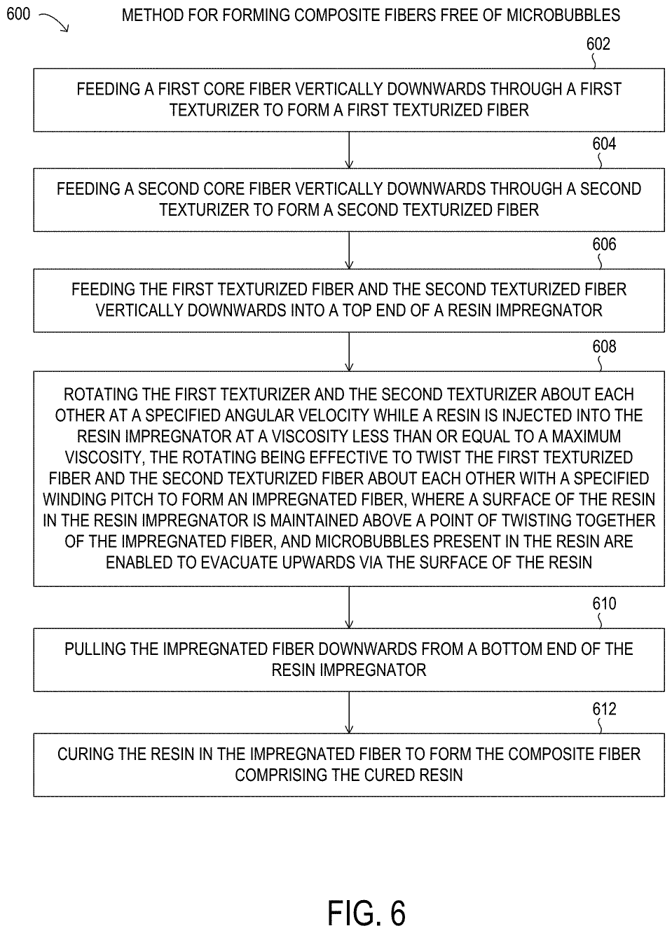

Referring now to FIG. 6, a method 600 for forming composite fibers free of microbubbles is shown in flow chart form. Method 600 may be used to form the improved composite fibers disclosed herein, such as by using improved pultrusion process 300 (see FIGS. 3A, 3B) or using improved pultrusion apparatus 400 (see FIG. 4) or both, which disclose forming composite fibers free of microbubbles. It is noted that certain elements in method 600 may be omitted or rearranged in different embodiments.

Method 600 may begin at step 602 by feeding a first core fiber vertically downwards through a first texturizer to form a first texturized fiber. At step 604, a second core fiber is fed vertically downwards through a second texturizer to form a second texturized fiber. At step 608, the first texturized fiber and the second texturized fiber are fed vertically downwards into a top end of a resin impregnator. At step 610, the first texturizer and the second texturizer are rotated about each other at a specified angular velocity while a resin is injected into the resin impregnator at a viscosity less than or equal to a maximum viscosity, the rotating being effective to twist the first texturized fiber and the second texturized fiber about each other with a specified winding pitch to form an impregnated fiber, where a surface of the resin in the resin impregnator is maintained above a point of twisting together of the impregnated fiber, and where microbubbles present in the resin are enabled to evacuate upwards via the surface of the resin. At step 610, the impregnated fiber is pulled downwards from a bottom end of the resin impregnator. At step 612, the resin in the impregnated fiber is cured to form the composite fiber comprising the cured resin.

As disclosed herein, improved composite fibers, and structural materials mixed with the improved composite fibers, are produced by an improved process that vertically texturizes and impregnates resin into the fibers without introducing any substantial amount of microbubbles in the resin. By using vertical impregnation and twisting of fiber strands with specific viscosity control, stronger composite fibers, in which substantially no microbubbles are trapped, are produced with improved tensile strength and lower variance in tensile strength, for use in strengthening structural concrete and other structural materials.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of producing a composite fiber, the method comprising:
feeding a first core fiber vertically downwards through a first texturizer to form a first texturized fiber;
feeding a second core fiber vertically downwards through a second texturizer to form a second texturized fiber;
feeding the first texturized fiber and the second texturized fiber vertically downwards into a top end of a resin impregnator;
rotating the first texturizer and the second texturizer about each other at a specified angular velocity while a resin is injected into the resin impregnator at a viscosity less than or equal to a maximum viscosity, the rotating being effective to twist the first texturized fiber and the second texturized fiber about each other with a specified winding pitch to form an impregnated fiber, wherein a surface of the resin in the resin impregnator is maintained above a point of twisting together of the impregnated fiber, and wherein microbubbles present in the resin are enabled to evacuate upwards via the surface of the resin;
pulling the impregnated fiber downwards from a bottom end of the resin impregnator; and
curing the resin in the impregnated fiber to form the composite fiber comprising the cured resin.

2. The method of claim 1, wherein the maximum viscosity is 5 mPa*s.

3. The method of claim 1, wherein the specified angular velocity is effective to produce the specified winding pitch of at least 1 winding per inch.

4. The method of claim 1, further comprising:
pulling the impregnated fiber into a precuring channel to form a precured fiber; and
pulling the precured fiber into a shaper to impart a shape to the precured fiber to form a shaped fiber.

5. The method of claim 4, wherein the precured fiber has a resin viscosity of at least 10⁶ Pa*s.

6. The method of claim 4, wherein the shape is selected from at least one of: a wave, a triangle, a square, a curve, or an angle.

7. The method of claim 4, wherein the shape is periodic along the length of the shaped fiber.

8. The method of claim 4, further comprising:
pushing the shaped fiber into a curing channel to form the composite fiber; and
pushing the composite fiber to a cutter to cut the composite fiber to a desired length.

9. The method of claim 1, wherein the core fiber consists of basalt.

10. The method of claim 1, wherein the core fiber comprises at least one of: igneous rock fiber, carbon fiber, aramid fiber, and glass fiber.

11. The method of claim 10, wherein the igneous rock fiber comprises igneous rock selected from at least one of: feldspar, quartz, feldspathoid, olivine, pyroxene, amphibole, and mica.

12. The method of claim 1, wherein the composite fiber exhibits a variance in tensile strength of maximum 5% among different process batches.

13. A method of producing a structural composite material, the method comprising:
mixing a structural material for supporting structural loads with a composite fiber, wherein the composite fiber is produced according to a method comprising:
feeding a first core fiber vertically downwards through a first texturizer to form a first texturized fiber;
feeding a second core fiber vertically downwards through a second texturizer to form a second texturized fiber;
feeding the first texturized fiber and the second texturized fiber vertically downwards into a top end of a resin impregnator;
rotating the first texturizer and the second texturizer about each other at a specified angular velocity while a resin is injected into the resin impregnator at a viscosity less than or equal to a maximum viscosity, the rotating being effective to twist the first texturized fiber and the second texturized fiber about each other with a specified winding pitch to form an impregnated fiber, wherein a surface of the resin in the resin impregnator is maintained above a point of twisting together of the impregnated fiber, and wherein microbubbles present in the resin are enabled to evacuate upwards via the surface of the resin;
pulling the impregnated fiber downwards from a bottom end of the resin impregnator; and
curing the resin in the impregnated fiber to form the composite fiber comprising the cured resin.

14. The method of claim 13, wherein the structural material comprises at least one of: concrete, mortar, soil-stabilizing polymer, geo-polymer, and asphalt.

15. The method of claim 13, wherein the composite fiber is a shaped fiber.

16. The method of claim 13, wherein composite fiber is cut to a specified length.

17. The method of claim 13, wherein the core fiber consists of basalt.

18. The method of claim 13, wherein the core fiber comprises at least one of: igneous rock fiber, carbon fiber, aramid fiber, and glass fiber.

19. The method of claim 13, wherein the composite fiber exhibits a variance in tensile strength of maximum 5% among different process batches.

20. The method of claim 13, wherein mixing the structural material with the composite fiber further comprises:
mixing using a dry mix ratio of 12 pounds of the composite fiber to 1 cubic meter of the structural material, and wherein the structural material is a dry powder.
